(19) United States
(12) Patent Application Publication
(10) Pub. No.: US 2021/0203182 A1
(43) Pub. Date: Jul. 1, 2021

(54) SYSTEM INCLUDING A RECHARGEABLE BATTERY PACK FOR CONTINUOUSLY PROVIDING POWER TO A CELLULAR RADIO SYSTEM NOT YET CONNECTED TO THE ELECTRICAL GRID

(71) Applicant: Facility Solutions Group, Inc., Austin, TX (US)

(72) Inventors: Richard Joseph Hill, Round Rock, TX (US); Christopher Durocher, Pflugerville, TX (US); Justin McCullough, Round Rock, TX (US)

(21) Appl. No.: 16/730,163

(22) Filed: Dec. 30, 2019

(51) Int. Cl. H02J 9/06; H01Q 1/12; H02J 7/00

(52) U.S. Cl. CPC H02J 9/061; H02J 7/0068; H01Q 1/1242

(57) ABSTRACT

Systems including a rechargeable battery pack for continuously providing power to a cellular load system not yet connected to the electrical grid are provided. The system includes a rechargeable battery pack for continuously providing a requisite power to a specified electrical load, associated with at least one cellular radio system, for a time period including at least a time period between a request to an electricity supplier for a connection to an electrical grid for providing the requisite power to the specified load and a fulfillment of the request. The system further includes a standby battery pack and a first power source configurable to charge the rechargeable battery pack. The system further includes a power management system configured to: automatically configure the rechargeable battery pack or the standby battery pack to provide the requisite power and automatically reconfigure the rechargeable battery pack to function as a backup power source.

### BACKGROUND

Deployment of cellular networks that include small cells necessitates a larger number of cellular radio systems in a small geographic area. Each of the cellular radio systems may be installed on a pole, a cell tower, a building, or another support structure. Each installation of the cellular radio system may require the cellular infrastructure provider to obtain an electrical connection to power the cellular radio system. This process may take some time, including the time required by the electricity supplier (e.g., a power utility company) to deploy the electrical connection. The delay in powering up the cellular radio system causes delay in proving cellular services to the customers of the cellular service provider. Thus, there is a need for methods and systems to address such problems.

### SUMMARY

In one example, the present disclosure relates to a system including a rechargeable battery pack configured to continuously provide a requisite power to a specified electrical load, associated with at least one cellular radio system, for a predetermined time period, where the predetermined time period includes at least a time period between a request to an electricity supplier for a connection to an electrical grid for providing the requisite power to the specified load and a fulfillment of the request for the connection to the electrical grid. The system may further include a standby battery pack configured to power the specified electrical load when the rechargeable battery pack is not providing the requisite power to the specified electrical load. The system may further include a first power source configurable to charge the rechargeable battery pack. The system may further include a power management system coupled to the rechargeable battery pack, the standby battery pack, and the first power source, where the power management system is configured to: (1) automatically configure either the rechargeable battery pack or the standby battery pack to provide the requisite power to the specified electrical load, and (2) automatically reconfigure the rechargeable battery pack to function as a backup power source to the at least the first power source once the first power source is configured to provide the requisite power to the specified electrical load via the connection to the electrical grid.

In another example, the present disclosure relates to a system including a rechargeable battery pack configured to continuously provide a requisite power to a specified electrical load, associated with at least one cellular radio system, for a predetermined time period, where the predetermined time period includes at least a time period between a request to an electricity supplier for a connection to an electrical grid for providing the requisite power to the specified load and a fulfillment of the request for the connection to the electrical grid. The system may further include a standby battery pack configured to power the specified electrical load when the rechargeable battery pack is not providing the requisite power to the specified electrical load. The system may further include a first power source configured to charge the rechargeable battery pack. The system may further include a power management system coupled to the rechargeable battery pack, the standby battery pack, and the first power source, where the power management system is configured to: (1) automatically configure either the rechargeable battery pack or the standby battery pack to provide the requisite power to the specified electrical load, and (2) automatically reconfigure the rechargeable battery pack to function as a backup power source to the at least the first power source once the first power source is configured to provide the requisite power to the specified electrical load via the connection to the electrical grid. The system may further include a monitoring system coupled to the power management system, where the rechargeable battery pack comprises at least one replaceable battery, and where the monitoring system is configured to monitor a status of the at least one replaceable battery.

In yet another example, the present disclosure relates to a system including a rechargeable battery pack configured to continuously provide a requisite power to a specified electrical load, associated with at least one cellular radio system, for a predetermined time period, where the predetermined time period includes at least a time period between a request to an electricity supplier for a connection to an electrical grid for providing the requisite power to the specified load and a fulfillment of the request for the connection to the electrical grid. The system may further include a non-removable standby battery pack configured to power the specified electrical load when the rechargeable battery pack is not providing the requisite power to the specified electrical load. The system may further include a first power source configurable to charge the rechargeable battery pack. The system may further include a solar panel configured to provide at least a portion of the power to the specified electrical load. The system may further include a power management system coupled to the rechargeable battery pack, the non-removable standby battery pack, the first power source, the solar panel, where the power management system is configured to: (1) automatically configure either the rechargeable battery pack or the non-removable standby battery pack to provide the requisite power to the specified electrical load, (2) automatically configure the solar panel to provide the at least the portion of the power to the specified electrical load, and (3) automatically reconfigure the rechargeable battery pack to function as a backup power source to the at least the first power source once the first power source is configured to provide the requisite power to the specified electrical load via the connection to the electrical grid. The system may further include a monitoring system coupled to the power management system, where the rechargeable battery pack comprises at least one replaceable battery, and where the monitoring system is configured to monitor a status of at least one replaceable battery.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 shows a system including a rechargeable battery pack for continuously providing a requisite power to an electrical load associated with a cellular radio system in accordance with one example;

FIG. 2 shows a system environment including cellular radio systems coupled to rechargeable battery packs in accordance with one example;

FIG. 3 shows a power management system in accordance with one example;

FIG. 4 is a block diagram of an automatic transfer controller in accordance with one example; and

FIG. 5 is a graph showing power draw by the specified load associated with the cellular radio system and the backup power source operation in accordance with one example.

### DETAILED DESCRIPTION

Examples described in this disclosure relate to a system including a rechargeable battery pack for continuously providing power to an electrical load associated with a cellular radio system not yet connected to the electrical grid. Deployment of advanced cellular networks that increasingly include small cellular nodes (e.g., 5G node) necessitates the deployment of a larger number of cellular radio systems in a small geographic area. Each of the cellular radio systems may be installed on a pole, a cell tower, a building, or another support structure. Each installation of the cellular radio system requires the cellular infrastructure provider to obtain an electrical connection to power the cellular radio system. The cellular radio system and the power management system components may be installed within a short period of time (e.g., within ten days) of obtaining a request for the installation of the cellular radio system. In conventional deployments, however, the deployed cellular radio system, cannot be energized until the electricity supplier (e.g., a power utility company) provides the connection to the electrical grid. This process may take as long as another 60 days. The delay in powering up the cellular radio system causes delay in proving cellular services to the customers. The present disclosure describes a system that allows powering up of the cellular radio system even before the connection to the electrical grid is obtained.

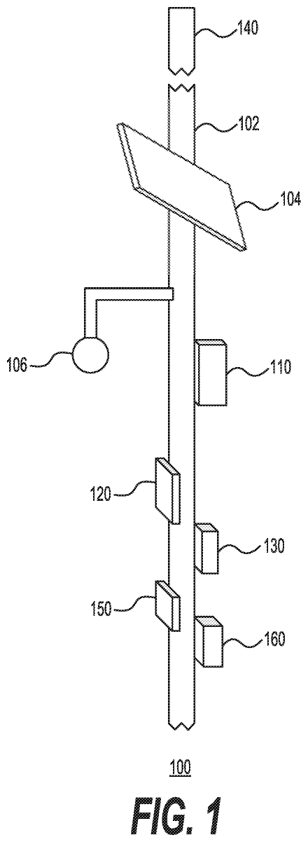

FIG. 1 shows a system 100 including a rechargeable battery pack for continuously providing a requisite power to an electrical load associated with a cellular radio system in accordance with one example. System 100 may include a pole 102 that may be used as a support structure for mounting other components of system 100. As an example, a solar panel 104 may be mounted on pole 102. A camera system 106 may also be mounted on pole 102. A power management system 110 may also be mounted on pole 102. A rechargeable battery pack 120 may also be mounted on pole 102. A cellular radio system 140 may be mounted at or near the top of pole 102. As used herein the term cellular radio system may include any combination of cellular equipment, including a cellular antenna. A standby battery pack 130 may be mounted on pole 102 as well. A monitoring system 150 may also be mounted on pole 102. A generator system 160 may be mounted on pole 102. Generator system 160 may also be supported by other support structures.

With continued reference to FIG. 1, rechargeable battery pack 120 may be configured to continuously provide a requisite power to a specified electrical load, associated with cellular radio system 140, for a predetermined time period. In one example, the predetermined time period includes at least a time period between a request to an electricity supplier for a connection to an electrical grid for providing the requisite power to the specified load and a fulfillment of the request for the connection to the electrical grid. In addition, when deployed, solar panel 104 may be used to charge rechargeable battery pack 120 whenever solar panel 104 can generate electricity by converting the solar energy into electricity. In such an example, the capacity of rechargeable battery pack 120 may be designed to take advantage of the recharge from solar panel 104. As used herein the term “battery pack” includes any housing or a structure that includes one or more batteries. Thus, even a single battery supported by any housing or a structure may be referred to as a battery pack. During the predetermined time period, the batteries within rechargeable battery pack 120 may be replaced or otherwise charged to ensure continuous power for the cellular radio system. In another example, generator system 160 may also be deployed to provide current to rechargeable battery pack 120. This may further allow for a different sizing of rechargeable battery pack 120.

Still referring to FIG. 1, standby battery pack 130 may be configured to power the specified electrical load when rechargeable battery pack 120 is not providing the requisite power to the specified electrical load. The specified electrical load may correspond to the average power draw associated with the cellular radio system. Example specified electrical load may include power draw within a range of 200 watts to 900 watts at 120 volts. In one example, standby battery pack 130 may keep the cellular radio system powered for a time duration that is long enough to allow a technician to replace one or more batteries in rechargeable battery pack 120. This way the cellular radio system may not experience any power loss even when rechargeable battery pack 120 is not available and the connection to the electrical grid is not yet available.

With continued reference to FIG. 1, in one example, power management system 110 may be configured to: (1) automatically connect either rechargeable battery pack 120 or standby battery pack 130 to provide the requisite power to the specified electrical load, and (2) automatically connect the power derived from an electrical grid to charge rechargeable battery pack 130.

Still referring to FIG. 1, generator system 160 may be any generator, such as a fossil-fuel engine (e.g., diesel engine) based generator, that can use the fuel to generate electricity. The capacity of generator system 160 may be designed based on the electrical load specifications of cellular radio system 140 and other considerations related to the typical time period between a request for an electrical connection to the electrical grid and a fulfillment of the connection request. Solar panel 104 may be any photovoltaic panel that can convert solar energy into electricity. The size and the performance of solar panel 104 may be selected in combination with the availability of other power sources for rechargeable battery pack 120. Thus, if generator system 160 is not deployed, then solar panel 104 may be configured to provide more power than otherwise.

Advantageously, using rechargeable battery pack 120, cellular radio system 140 may be powered up without any connection to the electrical grid. In addition, once the electrical grid connection is available, rechargeable battery pack 120 may act as a backup power supply for cellular radio system 140. As explained later, many of the aspects associated with powering cellular radio system 140 are automated to allow for automatic operation under the control of power management system 110. Although FIG. 1 shows a certain number of components of system 100 arranged in a certain manner, there could be more or fewer number of components arranged differently. As an example, a miniature weather system may also be mounted on pole 102 to measure not only the temperature, but also humidity, precipitation, barometric pressure, wind speed, or other weather related parameters. In addition, power may be obtained from other power sources, including wind turbines etc.

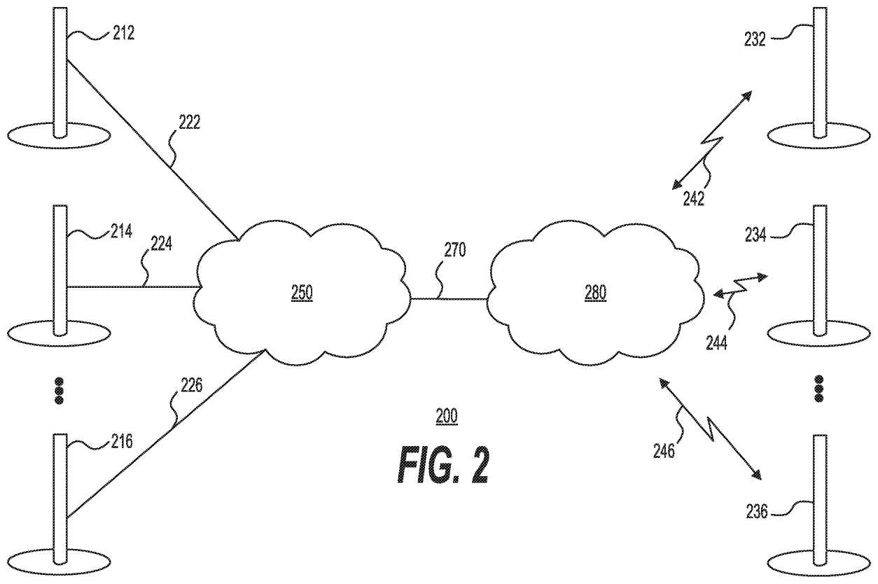

FIG. 2 shows a system environment 200 including systems with cellular radio systems coupled to rechargeable battery packs in accordance with one example. System environment 200 may include multiple systems (e.g., system 100) interconnected via various types of networks, including wired networks and wireless networks. The interconnected systems may provide cellular coverage for certain customers of the cellular provider. As an example, system 212 may be coupled to network infrastructure 250 via a link 222. System 214 may be coupled to network infrastructure 250 via a link 224. System 216 may be coupled to network infrastructure 250 via a link 226. Each of links 222, 224, and 226 may be any of fiber, copper, or other types of wired links. Network infrastructure 250 may include any of a combination of network switches, 5G infrastructure, 4G infrastructure, cloud computing infrastructure, or other types of cellular/computing infrastructure.

With continued reference to FIG. 2, system 232 may be coupled via a wireless link 242 to network infrastructure 280. System 234 may be coupled via a wireless link 244 to network infrastructure 280. System 236 may be coupled via a wireless link 246 to network infrastructure 280. Each of wireless links 242, 244, and 246 may be fixed wireless or other types of wireless links. Network infrastructure 280 may include any of a combination of network switches, 5G infrastructure, 4G infrastructure, cloud computing infrastructure, or other types of cellular/computing infrastructure. Network infrastructure 250 may be coupled via a link 270 to network infrastructure 280. Link 270 may be any of the wired links or wireless links described earlier. Cloud computing may refer to a model for enabling on-demand network access to a shared pool of configurable computing resources. The shared pool of configurable computing resources can be rapidly provisioned via virtualization and released with low management effort or service provider interaction, and then scaled accordingly. A cloud computing model can be composed of various characteristics such as, for example, on-demand self-service, broad network access, resource pooling, rapid elasticity, measured service, and so forth. Although FIG. 2 shows a certain number of components of system environment 200 arranged in a certain manner, there could be more or fewer number of components arranged differently.

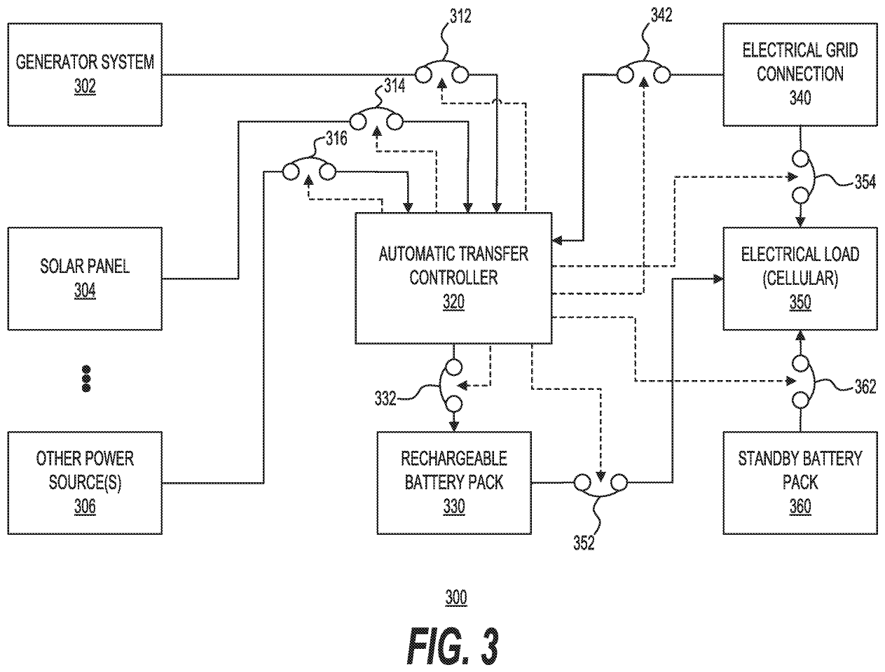

FIG. 3 shows a power management system 300 in accordance with one example. Power management system 300 may include different types of power sources, including an electrical grid, configured to ensure power to a cellular radio system. In this example, power management system 300 may include a generator system 302, a solar panel 304, other power source(s) 306, automatic transfer controller 320, rechargeable battery pack 330, electrical grid connection 340, electrical load (e.g., cellular radio system's electrical load) 350, and standby battery pack 360. Generator system 302 may be any generator (e.g., similar to generator 160 described earlier), such as a fossil-fuel based generator, that can use the fuel to generate electricity. The capacity of generator system 302 may be designed based on electrical load 350. Solar panel 304 may be any photovoltaic panel (e.g., similar to solar panel 104 described earlier) that can convert solar energy into electricity. The size and the performance of solar panel 304 may be selected in combination with the availability of other power sources for rechargeable battery pack 330. Thus, if generator system 302 is not deployed, then solar panel 304 may be configured to provide more power than otherwise. Other power source(s) 306 may include any other type of power sources that could be used in lieu of, or in combination with, generator system 302 and solar panel 304. The DC power output by any of these power sources may be converted to AC power using a DC/AC converter and then supplied to the electrical load associated with the cellular radio system. Electrical grid connection 340 may be a three-phase AC or a single-phase AC power connection.

With continued reference to FIG. 3, each of the input sources of power, such as generator system 302, may include an automatic transfer switch configured to automatically detect the availability of power via the source connected to that input and allow for the provision of the power from that input. Automatic transfer controller 320 may include logic and/or instructions configured to control the behavior of various switches, circuit breakers, relays, or other components allowing for the selection of power sources for the electrical load corresponding to the cellular radio system, as needed. As an example, with respect to the input sources of power, automatic transfer controller 320 may control the behavior of switch 312 and thereby couple or decouple generator system 302. Automatic transfer controller 320 may further control the behavior of switch 314 and thereby couple or decouple solar panel 304. Automatic transfer controller 320 may further control the behavior of switch 316 and thereby couple or decouple other power source(s) 306. In one example, automatic transfer controller 320 may automatically configure generator system 302 to charge the rechargeable battery pack 330 during at least a time period between the request to the electricity supplier for the connection to the electrical grid for providing the requisite power to electrical load 350 and the fulfillment of the request for the connection to the electrical grid. In another example, automatic transfer controller 320 may automatically configure solar panel 304 to charge the rechargeable battery pack 330 during at least a time period between the request to the electricity supplier for the connection to the electrical grid for providing the requisite power to electrical load 350 and the fulfillment of the request for the connection to the electrical grid.

Still referring to FIG. 3, automatic transfer controller 320 may: (1) automatically configure either rechargeable battery pack 330 or standby battery pack 360 to provide the requisite power to electrical load 350, and (2) automatically reconfigure rechargeable battery pack 330 to function as a backup power source to the at least the first power source (e.g., the electrical grid connection) once the first power source is configured to provide the requisite power to electrical load 350 via the connection to the electrical grid

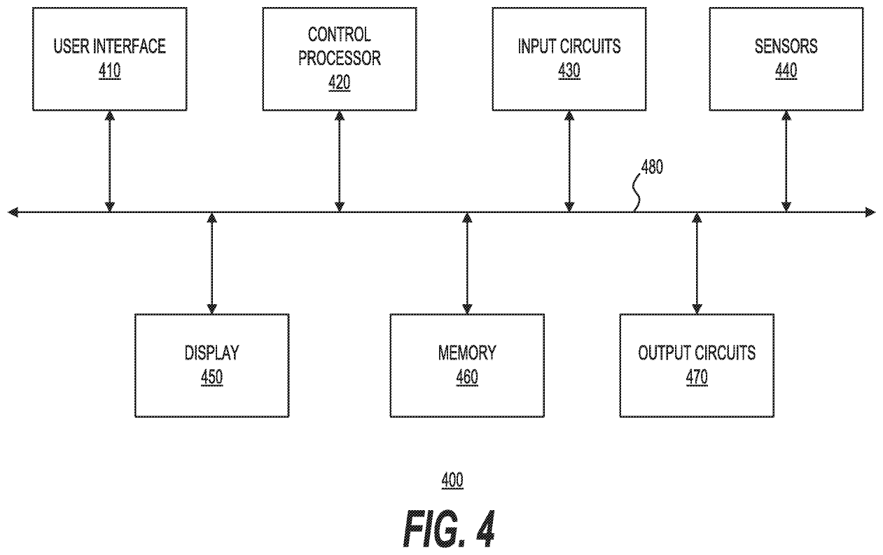

With continued reference to FIG. 3, automatic transfer controller 320 may control the behavior of switch 332 to allow or not allow the charging of rechargeable battery pack 330. Automatic transfer controller 320 may further control the behavior of switch 342 to allow the output of AC voltage/current from electrical grid connection 340 to flow to rechargeable battery pack 330. Automatic transfer controller 320 may further control the behavior of switch 352 to allow the output of rechargeable battery pack 330 to provide power to electrical load 350. Automatic transfer controller 320 may further control the behavior of switch 354 to allow the output of AC voltage/current from electrical grid connection 340 to electrical load 350. Automatic transfer controller 320 may further control the behavior of switch 362 to allow the output of standby battery pack 360 to flow to electrical load 350. Standby battery pack 360 may include a DC/AC converter since the cellular radio system load requires AC voltage/current. Although FIG. 3 shows a certain number of components of power management system 300 arranged in a certain manner, there could be more or fewer number of components arranged differently. Further details of automatic transfer controller 320 are provided with respect to FIG. 4 and related description.

FIG. 4 is a block diagram of an automatic transfer controller 400 in accordance with one example. In this example, automatic transfer controller may be used to provide the functionality associated with automatic transfer controller 330 in power management system 300. Automatic transfer controller 400 may include a user interface 410, a control processor 420, input circuits 430, sensors 440, display 450, memory 460, and output circuits 470. In one example, these components may be coupled via a bus system 480. Bus system 480 may be any combination of signal lines or other busses. User interface 410 may be implemented as a touch interface, a voice interface, a keypad interface, or any combination of input devices. User interface 410 may allow a service technician to configure power management system 300 for use with an electrical load associated with a cellular radio system. Control processor 420 may execute instructions (firmware, software, or a combination of any such types of instructions) to process input signals and generate output signals. Control processor 420 may be implemented using any of the processing cores, such as an ARM core or other types of cores. Control processor 420 may also include, or implement, various timers needed for managing any timing issues associated with the stabilization of electric power input or output.

With continued reference to FIG. 4, input circuits 430 may include transformers, relays, voltage conditioning circuits, A/D converters, low pass filters or other such components to process signals received by automatic transfer controller 400. As an example, any electrical output from any of the power sources, when received by automatic transfer controller 400, may first be processed by input circuits 430. The processing may include using a transformer to lower the voltage associated with the input signal and then conditioning the signal further via voltage conditioning circuits (e.g., level shifters) and A/D converters before being processed by control processor 420.

Still referring to FIG. 4, sensors 470 may include image sensors, voltage sensors, current sensors, and frequency sensors. Image sensors may include camera 106 described earlier. Voltage sensors may be used to monitor and sense the voltage level associated with any of the power sources described earlier. Current sensors may be used to monitor and sense the current magnitude associated with any of the power sources described earlier. Frequency sensors may include sensors for keeping track of the frequency of any alternating current power sources. Sensors 440 may also include telemetry or other types of sensors configured to detect, and/or receive, information (e.g., the condition of the various batteries and the status of the electrical grid). In one example, the combination of the appropriate sensors with instructions stored in memory 460 may allow the monitoring of a status (e.g., the remaining charge level or the capacity of the battery to provide current) of the replaceable batteries included in rechargeable battery pack 330.

With continued reference to FIG. 4, display 450 may be any type of display, such as LCD, LED, or other types of display. Display 450 may be used to present information to a technician, including information related to the status of the various components associated with power management system 300. Memory 460 may store instructions, which when executed by control processor 420, may perform the various functions associated with power management system 300. Memory 460 may be any combination of non-volatile storage or volatile storage (e.g., flash memory, DRAM, SRAM, or other types of memories).

Still referring to FIG. 4, output circuits 470 may include D/A converters, voltage conditioning circuits, transformers, relays, solenoid circuits to open/close circuit breakers, and other such components to process signals provided by automatic transfer controller 400 to other parts of power management system 300. Although FIG. 4 shows a certain number of components of automatic transfer controller 400 arranged in a certain manner, there could be more or fewer number of components arranged differently.

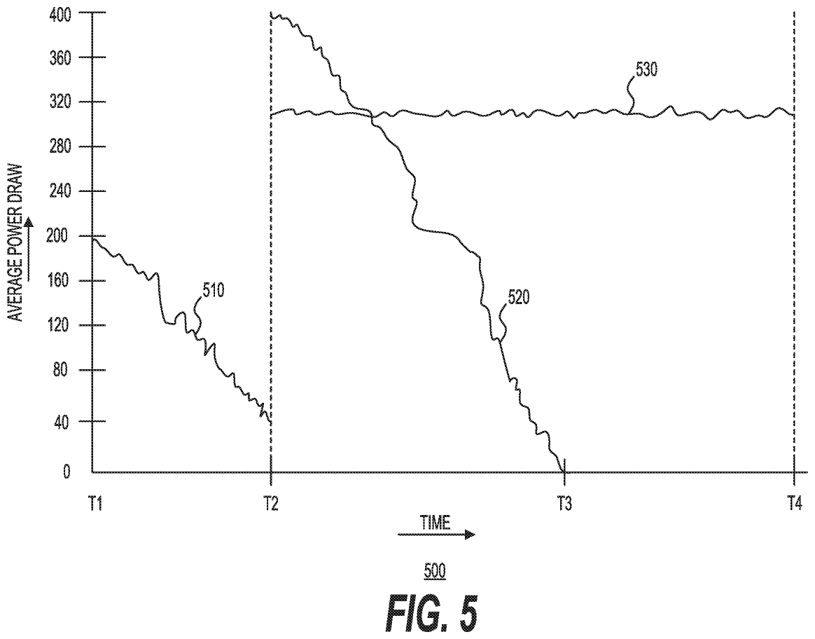

FIG. 5 is a graph 500 showing a simulation of power draw by the specified load associated with the cellular radio system and the backup power source operation in accordance with one example. The vertical axis of graph 500 shows the average power draw by the cellular radio system and the horizontal axis of graph 500 shows the time. In this example, the cellular radio system is assumed to draw 300 watts of power to support the specified electrical load associated with the cellular radio system. The specified electrical load may be the maximum load or another load value. At time instance T1, under the control of the automatic transfer controller (e.g., automatic transfer controller 320 of FIG. 3), the cellular radio system is being powered via the power received through the electrical grid connection. During this time, graph 510 shows the power draw from the rechargeable battery pack (e.g., rechargeable battery pack 330 of FIG. 3). At time instance T2, it is assumed that there is a disruption in the power being supplied via the electrical connection (e.g., the grid power is no longer available). Automatic transfer controller 320 senses the power loss and automatically starts to route power from the rechargeable battery pack to the cellular radio system. In addition, in response to the loss of the electrical power, automatic transfer controller 320 automatically starts routing any power being supplied by a solar panel (e.g., solar panel 304 of FIG. 3).

With continued reference to FIG. 5, graph 520 shows a simulated version of the power draw from the solar panel. It is assumed that as the sunlight goes away, at time instant T3, the solar panel stops providing any power. Graph 530 shows a simulated version of the full power draw (e.g., 300 watts) from the rechargeable battery pack. At time instant T4, the rechargeable battery pack loses all of its ability to continue to supply power and unless another power source (e.g., a generator system) can step in, no power is available to the cellular radio system. Automatic transfer controller 320 (also described as automatic transfer controller 400) can sense all of these changes in the power supply and the status of the rechargeable battery pack. Using wired or wireless links, this information can be transmitted to any device, station, or other monitoring systems.

In conclusion, in one example, the present disclosure relates to a system including a rechargeable battery pack configured to continuously provide a requisite power to a specified electrical load, associated with at least one cellular radio system, for a predetermined time period, where the predetermined time period includes at least a time period between a request to an electricity supplier for a connection to an electrical grid for providing the requisite power to the specified load and a fulfillment of the request for the connection to the electrical grid. The system may further include a standby battery pack configured to power the specified electrical load when the rechargeable battery pack is not providing the requisite power to the specified electrical load. The system may further include a first power source configurable to charge the rechargeable battery pack. The system may further include a power management system coupled to the rechargeable battery pack, the standby battery pack, and the first power source, where the power management system is configured to: (1) automatically configure either the rechargeable battery pack or the standby battery pack to provide the requisite power to the specified electrical load, and (2) automatically reconfigure the rechargeable battery pack to function as a backup power source to the at least the first power source once the first power source is configured to provide the requisite power to the specified electrical load via the connection to the electrical grid.

The power management system may be configured to automatically configure the first power source to provide the requisite power to the specified electrical load via the connection to the electrical grid. The power management system may comprise an automatic transfer controller.

The system may further comprise a generator system, and where the automatic transfer controller is configured to automatically configure the generator system to charge the rechargeable battery pack during at least a time period between the request to the electricity supplier for the connection to the electrical grid for providing the requisite power to the specified load and the fulfillment of the request for the connection to the electrical grid. The system may further comprise a solar panel, and where the automatic transfer controller is configured to automatically configure the solar panel to charge the rechargeable battery pack during at least a time period between the request to the electricity supplier for the connection to the electrical grid for providing the requisite power to the specified load and the fulfillment of the request for the connection to the electrical grid.

The rechargeable battery pack may include a plurality of lithium-ion batteries. The power management system may further comprise a plurality of circuit breakers, and where the automatic transfer controller is configured to control each of the plurality of circuit breakers.

In another example, the present disclosure relates to a system including a rechargeable battery pack configured to continuously provide a requisite power to a specified electrical load, associated with at least one cellular radio system, for a predetermined time period, where the predetermined time period includes at least a time period between a request to an electricity supplier for a connection to an electrical grid for providing the requisite power to the specified load and a fulfillment of the request for the connection to the electrical grid. The system may further include a standby battery pack configured to power the specified electrical load when the rechargeable battery pack is not providing the requisite power to the specified electrical load. The system may further include a first power source configured to charge the rechargeable battery pack. The system may further include a power management system coupled to the rechargeable battery pack, the standby battery pack, and the first power source, where the power management system is configured to: (1) automatically configure either the rechargeable battery pack or the standby battery pack to provide the requisite power to the specified electrical load, and (2) automatically reconfigure the rechargeable battery pack to function as a backup power source to the at least the first power source once the first power source is configured to provide the requisite power to the specified electrical load via the connection to the electrical grid. The system may further include a monitoring system coupled to the power management system, where the rechargeable battery pack comprises at least one replaceable battery, and where the monitoring system is configured to monitor a status of the at least one replaceable battery.

The power management system may be configured to automatically configure the first power source to provide the requisite power to the specified electrical load via the connection to the electrical grid. The power management system may comprise an automatic transfer controller.

The system may further comprise a generator system, and where the automatic transfer controller is configured to automatically configure the generator system to charge the rechargeable battery pack during at least a time period between the request to the electricity supplier for the connection to the electrical grid for providing the requisite power to the specified load and the fulfillment of the request for the connection to the electrical grid. The system may further comprise a solar panel, and where the automatic transfer controller is configured to automatically configure the solar panel to charge the rechargeable battery pack during at least a time period between the request to the electricity supplier for the connection to the electrical grid for providing the requisite power to the specified load and the fulfillment of the request for the connection to the electrical grid.

The at least one replaceable battery may be a lithium-ion battery. The power management system may further comprise a plurality of circuit breakers, and where the automatic transfer controller is configured to control each of the plurality of circuit breakers.

In yet another example, the present disclosure relates to a system including a rechargeable battery pack configured to continuously provide a requisite power to a specified electrical load, associated with at least one cellular radio system, for a predetermined time period, where the predetermined time period includes at least a time period between a request to an electricity supplier for a connection to an electrical grid for providing the requisite power to the specified load and a fulfillment of the request for the connection to the electrical grid. The system may further include a non-removable standby battery pack configured to power the specified electrical load when the rechargeable battery pack is not providing the requisite power to the specified electrical load. The system may further include a first power source configurable to charge the rechargeable battery pack. The system may further include a solar panel configured to provide at least a portion of the power to the specified electrical load. The system may further include a power management system coupled to the rechargeable battery pack, the non-removable standby battery pack, the first power source, the solar panel, where the power management system is configured to: (1) automatically configure either the rechargeable battery pack or the non-removable standby battery pack to provide the requisite power to the specified electrical load, (2) automatically configure the solar panel to provide the at least the portion of the power to the specified electrical load, and (3) automatically reconfigure the rechargeable battery pack to function as a backup power source to the at least the first power source once the first power source is configured to provide the requisite power to the specified electrical load via the connection to the electrical grid. The system may further include a monitoring system coupled to the power management system, where the rechargeable battery pack comprises at least one replaceable battery, and where the monitoring system is configured to monitor a status of at least one replaceable battery.

The power management system may be configured to automatically configure the first power source to provide the requisite power to the specified electrical load via the connection to the electrical grid. The power management system may comprise an automatic transfer controller.

The system may further comprise a generator system, and where the power management system is configured to automatically configure the generator system to charge the rechargeable battery pack during at least a time period between the request to the electricity supplier for the connection to the electrical grid for providing the requisite power to the specified load and the fulfillment of the request for the connection to the electrical grid. The system may further comprise a solar panel, and where the power management system is configured to automatically configure the solar panel to charge the rechargeable battery pack during at least a time period between the request to the electricity supplier for the connection to the electrical grid for providing the requisite power to the specified load and the fulfillment of the request for the connection to the electrical grid. The power management system may further comprise a plurality of circuit breakers, and where the automatic transfer controller is configured to control each of the plurality of circuit breakers.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Exemplary transmission media may include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A system comprising:
a rechargeable battery pack configured to continuously provide a requisite power to a specified electrical load, associated with at least one cellular radio system, for a predetermined time period, wherein the predetermined time period includes at least a time period between a request to an electricity supplier for a connection to an electrical grid for providing the requisite power to the specified load and a fulfillment of the request for the connection to the electrical grid;
a standby battery pack configured to power the specified electrical load when the rechargeable battery pack is not providing the requisite power to the specified electrical load;
a first power source configurable to charge the rechargeable battery pack; and
a power management system coupled to the rechargeable battery pack, the standby battery pack, and the first power source, wherein the power management system is configured to: (1) automatically configure either the rechargeable battery pack or the standby battery pack to provide the requisite power to the specified electrical load, and (2) automatically reconfigure the rechargeable battery pack to function as a backup power source to the at least the first power source once the first power source is configured to provide the requisite power to the specified electrical load via the connection to the electrical grid.

2. The system of claim 1, wherein the power management system is configured to automatically configure the first power source to provide the requisite power to the specified electrical load via the connection to the electrical grid.

3. The system of claim 2, wherein the power management system comprises an automatic transfer controller.

4. The system of claim 3, wherein the system further comprises a generator system, and wherein the automatic transfer controller is configured to automatically configure the generator system to charge the rechargeable battery pack during at least a time period between the request to the electricity supplier for the connection to the electrical grid for providing the requisite power to the specified load and the fulfillment of the request for the connection to the electrical grid.

5. The system of claim 3, wherein the system further comprises a solar panel, and wherein the automatic transfer controller is configured to automatically configure the solar panel to charge the rechargeable battery pack during at least a time period between the request to the electricity supplier for the connection to the electrical grid for providing the requisite power to the specified load and the fulfillment of the request for the connection to the electrical grid.

6. The system of claim 1, wherein the rechargeable battery pack comprises a plurality of lithium-ion batteries.

7. The system of claim 3, wherein the power management system further comprises a plurality of circuit breakers, and wherein the automatic transfer controller is configured to control each of the plurality of circuit breakers.

8. A system comprising:
a rechargeable battery pack configured to continuously provide a requisite power to a specified electrical load, associated with at least one cellular radio system, for a predetermined time period, wherein the predetermined time period includes at least a time period between a request to an electricity supplier for a connection to an electrical grid for providing the requisite power to the specified load and a fulfillment of the request for the connection to the electrical grid;
a standby battery pack configured to power the specified electrical load when the rechargeable battery pack is not providing the requisite power to the specified electrical load;
a first power source configurable to charge the rechargeable battery pack;
a power management system coupled to the rechargeable battery pack, the standby battery pack, and the first power source, wherein the power management system is configured to: (1) automatically configure either the rechargeable battery pack or the standby battery pack to provide the requisite power to the specified electrical load, and (2) automatically reconfigure the rechargeable battery pack to function as a backup power source to the at least the first power source once the first power source is configured to provide the requisite power to the specified electrical load via the connection to the electrical grid; and
a monitoring system coupled to the power management system, wherein the rechargeable battery pack comprises at least one replaceable battery, and wherein the monitoring system is configured to monitor a status of the at least one replaceable battery.

9. The system of claim 8, wherein the power management system is configured to automatically configure the first power source to provide the requisite power to the specified electrical load via the connection to the electrical grid.

10. The system of claim 9, wherein the power management system comprises an automatic transfer controller.

11. The system of claim 10, wherein the system further comprises a generator system, and wherein the automatic transfer controller is configured to automatically configure the generator system to charge the rechargeable battery pack during at least a time period between the request to the electricity supplier for the connection to the electrical grid for providing the requisite power to the specified load and the fulfillment of the request for the connection to the electrical grid.

12. The system of claim 10, wherein the system further comprises a solar panel, and wherein the automatic transfer controller is configured to automatically configure the solar panel to charge the rechargeable battery pack during at least a time period between the request to the electricity supplier for the connection to the electrical grid for providing the requisite power to the specified load and the fulfillment of the request for the connection to the electrical grid.

13. The system of claim 8, wherein the at least one replaceable battery is a lithium-ion battery.

14. The system of claim 10, wherein the power management system further comprises a plurality of circuit breakers, and wherein the automatic transfer controller is configured to control each of the plurality of circuit breakers.

15. A system comprising:
a rechargeable battery pack configured to continuously provide a requisite power to a specified electrical load, associated with at least one cellular radio system, for a predetermined time period, wherein the predetermined time period includes at least a time period between a request to an electricity supplier for a connection to an electrical grid for providing the requisite power to the specified load and a fulfillment of the request for the connection to the electrical grid;
a non-removable standby battery pack configured to power the specified electrical load when the rechargeable battery pack is not providing the requisite power to the specified electrical load;
a first power source configurable to charge the rechargeable battery pack;
a solar panel configured to provide at least a portion of the power to the specified electrical load;
a power management system coupled to the rechargeable battery pack, the non-removable standby battery pack, the first power source, and the solar panel, wherein the power management system is configured to: (1) automatically configure either the rechargeable battery pack or the non-removable standby battery pack to provide the requisite power to the specified electrical load, (2) automatically configure the solar panel to provide the at least the portion of the power to the specified electrical load, and (3) automatically reconfigure the rechargeable battery pack to function as a backup power source to the at least the first power source once the first power source is configured to provide the requisite power to the specified electrical load via the connection to the electrical grid; and
a monitoring system coupled to the power management system, wherein the rechargeable battery pack comprises at least one replaceable battery, and wherein the monitoring system is configured to monitor a status of at least one replaceable battery.

16. The system of claim 15, wherein the power management system is configured to automatically configure the first power source to provide the requisite power to the specified electrical load via the connection to the electrical grid.

17. The system of claim 16, wherein the power management system comprises an automatic transfer controller.

18. The system of claim 16, wherein the system further comprises a generator system, and wherein the power management system is configured to automatically configure the generator system to charge the rechargeable battery pack during at least a time period between the request to the electricity supplier for the connection to the electrical grid for providing the requisite power to the specified load and the fulfillment of the request for the connection to the electrical grid.

19. The system of claim 16, wherein the system further comprises a solar panel, and wherein the power management system is configured to automatically configure the solar panel to charge the rechargeable battery pack during at least a time period between the request to the electricity supplier for the connection to the electrical grid for providing the requisite power to the specified load and the fulfillment of the request for the connection to the electrical grid.

20. The system of claim 15, wherein the power management system further comprises a plurality of circuit breakers, and wherein the automatic transfer controller is configured to control each of the plurality of circuit breakers.
